(19) United States
(12) Patent Application Publication
(10) Pub. No.: US 2025/0333052 A1
(43) Pub. Date: Oct. 30, 2025

(54) VEHICEL CONTROL DEVICE AND METHOD THROUGH CUT-IN DETERMINATION

(71) Applicant: HL Klemove Corp., Incheon (KR)

(72) Inventor: Bo Ryeon KANG, Incheon (KR)

(73) Assignee: HL Klemove Corp., Incheon (KR)

(21) Appl. No.: 18/903,355

(22) Filed: Oct. 1, 2024

(30) Foreign Application Priority Data
Apr. 30, 2024 (KR) 10-2024-0057346

(51) Int. Cl. B60W 30/095; B60W 30/18; B60W 50/14

(52) U.S. Cl. CPC B60W 30/0956; B60W 30/0953; B60W 30/18163; B60W 50/14; B60W 2554/4043; B60W 2554/806

(57) ABSTRACT

The present embodiments relate to a vehicle control method and device capable of receiving detection information related to a host vehicle and a surrounding vehicle, and determining the presence of a cut-in candidate vehicle based on a cut-in intention determination result for the surrounding vehicle based on the detection information, and determining the presence of a cut-in vehicle based on a position within a lane of the cut-in candidate vehicle if the cut-in candidate vehicle exists.

### CROSS REFERENCE TO RELATED APPLICATION

This application claims priority from Korean Patent Application No. 10-2024-0057346, filed on Apr. 30, 2024, which is hereby incorporated by reference for all purposes as if fully set forth herein.

### TECHNICAL FIELD

An embodiment of the present disclosure relates to a vehicle control device and a vehicle control method for determining a cut-in.

### BACKGROUND

An adaptive cruise control (ACC) system is a driver assistance system capable of detecting a preceding vehicle using a sensing device installed in a vehicle according to conditions set in an autonomous driving environment, and automatically controlling acceleration or deceleration of the vehicle according to a speed of the preceding vehicle to maintain a safe distance.

The ACC system may perform autonomous driving at a speed set by a driver, automatically maintain the distance to the preceding vehicle, automatically stop the vehicle when the preceding vehicle stops, and support a function of restarting the vehicle when the preceding vehicle starts again.

If a cut-in vehicle cuts in from the adjacent lane while the vehicle is driving on a road, the ACC system may change the preceding vehicle to a cut-in vehicle, and then may reduce the speed of the vehicle to maintain a safe distance to the cut-in vehicle as a new preceding vehicle.

However, there is a problem in that it is difficult to determine the intention of a driver of a vehicle driving in the next lane, so that it is difficult to determine whether the vehicle driving in the next lane is a vehicle cutting in or a vehicle driving straight without the cut-in, and thus there may unnecessarily slow down the vehicle due to a misdetermination of the cut-in of another vehicle.

Therefore, there is required a method to accurately determine the intention of a surrounding vehicle driving in the surrounding lane.

### SUMMARY

Embodiments of the present disclosure are to provide a vehicle control method and device capable of determining a cut-in of another vehicle.

In accordance with an aspect of the present disclosure, there may be provided a vehicle control device including a receiver for receiving detection information related to a host vehicle and a surrounding vehicle, and a controller configured to determine the presence of a cut-in candidate vehicle based on a cut-in intention determination result for the surrounding vehicle based on the detection information, and determine the presence of a cut-in vehicle based on a position within a lane of the cut-in candidate vehicle if the cut-in candidate vehicle exists.

In accordance with another aspect of the present disclosure, there may be provided a vehicle control method including receiving detection information related to a host vehicle and a surrounding vehicle, and determining the presence of a cut-in candidate vehicle based on a cut-in intention determination result for the surrounding vehicle based on the detection information, and determining the presence of a cut-in vehicle based on a position within a lane of the cut-in candidate vehicle if the cut-in candidate vehicle exists.

According to an embodiment of the present disclosure, it is possible to provide a vehicle control method and device capable of determining a cut-in of another vehicle.

### BRIEF DESCRIPTION OF THE DRAWINGS

FIG. 1 is a diagram for explaining the configuration of a vehicle control device for controlling a host vehicle according to the result of determining a cut-in intention of a surrounding vehicle according to an embodiment.

FIG. 2 is a flowchart for schematically explaining a process of controlling a host vehicle in response to a cut-in vehicle according to an embodiment.

FIG. 3 is a flowchart for explaining a process of determining whether a surrounding vehicle is a cut-in vehicle according to one embodiment.

FIG. 4 is a diagram for explaining a method for determining a position of a surrounding vehicle according to an embodiment.

FIG. 5 is a diagram for explaining a method for determining whether a cut-in candidate vehicle is a cut-in vehicle according to an embodiment.

FIG. 6 is a flowchart for explaining a process of controlling a host vehicle in response to the presence of a cut-in vehicle according to an embodiment.

FIG. 7 is a flowchart for exemplarily explaining the entire process of controlling a host vehicle according to the result of determining a cut-in intention of a surrounding vehicle according to an embodiment.

FIG. 8 is a flowchart for explaining a vehicle control method according to the result of determining a cut-in intention of a surrounding vehicle in an embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Cut-In may mean a situation in which a surrounding vehicle driving in an adjacent lane of a host vehicle moves to a lane of the host vehicle and cuts in front of the host vehicle. Alternatively, if the host vehicle changes lanes to an adjacent lane, a surrounding vehicle may cuts in front of the host vehicle.

Cut-Out may mean a situation in which a distance between a vehicle driving in front of a preceding vehicle and the host vehicle becomes shorter as the preceding vehicle changes lanes to an adjacent lane. The vehicle driving in front of the preceding vehicle may be a vehicle driving at a lower speed than the host vehicle or a stopped vehicle.

As a surrounding vehicle moves in front of the host vehicle through a cut-in, the corresponding surrounding vehicle may be located in front of the host vehicle which has been driving while maintaining a safe distance following the preceding vehicle, and accordingly, the host vehicle may slow down to maintain a safe distance.

Generally, there has been determined whether of a cut-in of a surrounding vehicle based on a driving speed of the surrounding vehicle. Specifically, the driving speed may be divided into a lateral speed, which refers to a speed in a direction perpendicular to the lane, and a longitudinal speed, which refers to a speed in a direction parallel to the lane. The host vehicle may determine whether a surrounding vehicle is a cut-in vehicle based on the lateral speed of the surrounding vehicle detected by a sensor.

However, a method of determining whether a surrounding vehicle is a cut-in vehicle by the lateral speed may have a problem in that a sensing means equipped in a vehicle may incorrectly detect the lateral speed, so that a surrounding vehicle may be misrecognized as a cut-in vehicle even if the surrounding vehicle is not actually a cut-in vehicle, thereby preforming unnecessary braking to the host vehicle.

For example, the sensing may mean equipped in the host vehicle, may measure the lateral speed as 30 km/h when the host vehicle approaches a surrounding vehicle. Since the surrounding vehicle is driving straight, even though there is no intention of cutting in, the surrounding vehicle may be misrecognized as a cut-in vehicle since the host vehicle is approaching the surrounding vehicle, and the driving speed of the host vehicle may be unnecessarily reduced. Alternatively, if a lateral speed of the surrounding vehicle may be incorrectly measured due to a problem in the sensing means, the driving speed of the host vehicle may be unnecessarily reduced.

In addition, if a cut-in of a surrounding vehicle is expected, the host vehicle may incorrectly identify a surrounding vehicle driving in the next lane as a preceding vehicle instead of the existing preceding vehicle, and may unnecessarily control the deceleration of the host vehicle.

Hereinafter, there may be proposed a method to determine whether there is a vehicle with a cut-in intention among the surrounding vehicles driving in the surrounding lane of the host vehicle, and to determine and control the driving speed of the host vehicle if a cut-in vehicle exists.

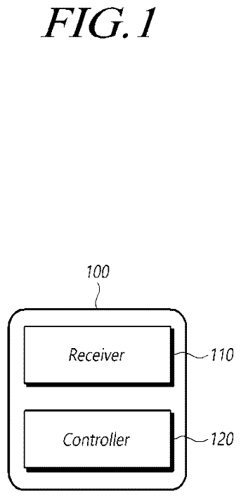

FIG. 1 is a diagram for explaining the configuration of a vehicle control device for controlling a host vehicle according to the result of determining a cut-in intention of a surrounding vehicle according to an embodiment.

Referring to FIG. 1, a vehicle control device 100 for controlling a host vehicle against a cut-in vehicle may include a receiver 110 for receiving detection information related to the host vehicle and a surrounding vehicle.

For example, the detection information received by the receiver 110 may include at least one of an expected driving path of the host vehicle, a lateral speed of a surrounding vehicle, a heading angle of a surrounding vehicle, and lane information between the host vehicle and the surrounding vehicle.

The detection information may be information detected by a sensing device equipped in the host vehicle. If the sensing device collects information about the host vehicle, surrounding vehicles, and lanes, the sensing device may transmit the collected information to the receiver of the present disclosure. The sensing device may be either a camera or a radar.

The vehicle control device 100 for controlling a host vehicle against a cut-in vehicle may include a controller 120 which determines the existence of a cut-in candidate vehicle based on a determination result of a cut-in intention of a surrounding vehicle based on detection information, and determines whether a cut-in vehicle exists based on the position of the cut-in candidate vehicle within the lane if a cut-in candidate vehicle exists.

The vehicle control device 100 of the present disclosure may first determine whether there is a cut-in candidate vehicle among surrounding vehicles based on preset determination criteria, and then determine whether there is a cut-in vehicle among the cut-in candidate vehicles based on a lateral speed and a position of the cut-in candidate vehicle, and then determine a driving speed of the host vehicle based on a relative speed of the cut-in vehicle and the host vehicle if there is a cut-in vehicle, and control the host vehicle based on the determined driving speed.

For example, the controller 120 may determine a surrounding vehicle as a cut-in candidate vehicle based on at least one of the expected driving path of the host vehicle, lateral speed of a surrounding vehicle, and heading angle of a surrounding vehicle.

The host vehicle and the surrounding vehicle may be autonomous vehicles controlled by a control center. The cut-in may be performed by either the host vehicle or the surrounding vehicle. The vehicle control device 100 of the present disclosure may determine whether a surrounding vehicle has a cut-in intention toward the host vehicle, and may control the speed of the host vehicle if the surrounding vehicle is a cut-in vehicle with a cut-in intention.

The controller 120 may primarily determine a vehicle expected to have a cut-in intention among the surrounding vehicles as a cut-in candidate vehicle or a cut-in reserve vehicle based on information received by the receiver 110. The determination of the surrounding vehicle as a cut-in candidate vehicle may be performed based on at least one of the expected driving path of the host vehicle, the lateral speed of the surrounding vehicle, and the heading angle of the surrounding vehicle.

The controller 120 may perform a preprocessing process of processing data into a state in which the information received by the receiver 110 is determined to be a cut-in vehicle. Alternatively, the receiver 110 may classify and store information on the type, width, height, position, etc. of the surrounding vehicles in a separate database based on the information on the surrounding vehicles received.

As another example, the controller 120 may determine the surrounding vehicle as a cut-in candidate vehicle if the lateral speed of the surrounding vehicle increases or the driving direction of the surrounding vehicle measured based on the heading angle of the surrounding vehicle overlaps with the expected driving path of the host vehicle. Specifically, the controller 120 may determine the surrounding vehicle as a cut-in candidate vehicle if the lateral speed of the surrounding vehicle increases, and then determine the driving direction of the surrounding vehicle through the heading angle of the surrounding vehicle and determine the surrounding vehicle as a cut-in candidate vehicle if the driving direction overlaps with the expected driving path of the host vehicle. However, since the sensor may incorrectly detect the lateral speed and it is not necessarily considered a collision will occur due to the overlapping of the driving paths, the cut-in intention of the surrounding vehicle may not be clearly determined based on the above-described criteria alone, and the cut-in intention may be misrecognized and the host vehicle may be decelerated unnecessarily. Therefore, the vehicle control device 100 of the present disclosure determines whether the cut-in candidate vehicle is a cut-in vehicle based on a vehicle position information for the primarily determined cut-in candidate vehicle.

As another example, the controller 120 may determine a cut-in candidate vehicle as a cut-in vehicle based on the lateral speed of the surrounding vehicle and a distance from the surrounding vehicle to a reference line.

The vehicle controller 100 may determine a cut-in candidate vehicle as a cut-in vehicle if it is determined that the cut-in candidate vehicle is rapidly approaching the host vehicle and the position of the surrounding vehicle is close to a preset reference line. The reference line may mean a specific location within a lane in which the host vehicle is driving, or may mean a specific location within a lane in which the surrounding vehicle is driving.

As another example, the controller 120 may determine the cut-in candidate vehicle as a cut-in vehicle if the lateral speed of the surrounding vehicle exceeds a first threshold and a distance from the surrounding vehicle to a reference line is less than or equal to a second threshold.

In determining a cut-in candidate vehicle as a cut-in vehicle, a reference value for the lateral speed and a reference value or threshold for the distance between the cut-in candidate vehicle and the reference line may be set in advance.

As another example, the distance from the surrounding vehicle to the reference line may be determined based on a position within the lane of the surrounding vehicle, and a position within the lane of the surrounding vehicle may be determined based on the received lane information between the host vehicle and the surrounding vehicle.

Specifically, the distance between the cut-in candidate vehicle and the reference line may be determined using information such as the position of the cut-in candidate vehicle within the lane, and a heading angle and a width of the cut-in candidate vehicle. In particular, since the possibility of collision with the host vehicle may vary depending on the width of the cut-in candidate vehicle, the distance from the cut-in candidate vehicle to the reference line may mean the shortest distance among the distances between each part of the cut-in candidate vehicle and the reference line.

In addition, the position of the cut-in candidate vehicle within the lane may be detected by a sensing means or a sensor equipped in the host vehicle. Alternatively, there may be received the position information measured through GPS.

Alternatively, the controller may determine the position of the cut-in candidate vehicle within the lane based on the information about the detected cut-in candidate vehicle and the lane information located between the cut-in candidate vehicle and the host vehicle. The information about the cut-in candidate vehicle may include width information of the cut-in candidate vehicle described above, and the lane information may include the location information of the lane. The distance between the cut-in candidate vehicle and the lane may be determined using the information about the cut-in candidate vehicle and the lane information, and the position of the cut-in candidate vehicle may be accurately measured based on the distance information. Therefore, the present disclosure proposes a method for determining the position of a cut-in candidate vehicle based on distance information between the cut-in candidate vehicle and the lane.

As another example, the controller 120 may determine the changed driving speed of the host vehicle based on the relative speed of the host vehicle and the cut-in vehicle if a cut-in vehicle exists. If the controller 120 may determine that there is a cut-in vehicle among the cut-in candidate vehicles, it is necessary to control the speed of the host vehicle to prevent a collision between the cut-in vehicle and the host vehicle. Therefore, the vehicle control device 100 of the present disclosure may determine the driving speed of the host vehicle. The present disclosure may refer to the determined driving speed of the host vehicle as a changed driving speed of the host vehicle. The controller 120 may determine the changed driving speed based on the relative speed between the host vehicle and a cut-in vehicle.

As another example, the controller 120 may control the host vehicle based on the determined changed driving speed.

As another example, the controller 120 may transmit a message notifying the risk of collision to the host vehicle if a cut-in candidate vehicle exists, and may transmit a message notifying the host vehicle that the risk of collision has been an error when a cut-in candidate vehicle exists and a cut-in vehicle does not exist. The host vehicle may have a driver on board, and the driver may control the host vehicle by himself/herself even though it is an autonomous vehicle. In this case, the vehicle control device of the present disclosure may notify the driver that there is a risk of collision with the cut-in candidate vehicle. The notification of the risk of collision may be transmitted as a voice through an audio device equipped in the host vehicle, or may be transmitted as a visual message through a display device equipped in the host vehicle. The method of notifying the driver of the risk is not limited thereto, and may be implemented in various ways depending on the vehicle type or condition of the host vehicle.

The vehicle control device 100 of the present disclosure accurately may determine whether a surrounding vehicle driving around the lane of the host vehicle has an intention to cut-in, and control the driving speed of the host vehicle according to the determination result while simultaneously notifying the driver of a collision risk. As a result, unnecessary deceleration control of the host vehicle may be avoided, and also, it is possible to prevent an accident with a vehicle approaching from the rear of the host vehicle by avoiding unnecessary deceleration.

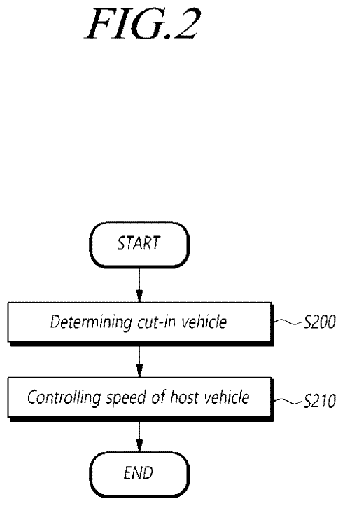

Hereinafter, it will be described in detail a process of determining whether a surrounding vehicle is a cut-in vehicle and controlling the host vehicle with reference to FIG. 2.

FIG. 2 is a flowchart for schematically explaining a process of controlling a host vehicle in response to a cut-in vehicle according to an embodiment.

Referring to FIG. 2, the process of controlling the host vehicle in response to a cut-in vehicle by the vehicle control device of the present disclosure may be performed as follows.

The vehicle control device may check whether there is a cut-in vehicle among the surrounding vehicles (S200). Specifically, the vehicle control device may receive the detection result of a vehicle driving around the host vehicle and determine whether there is a cut-in vehicle based on the received result. The present disclosure can refer to a vehicle driving around the host vehicle as a surrounding vehicle. If there is a surrounding vehicle, a vehicle expected to have an intention to perform a cut-in on the host vehicle among the surrounding vehicles may be first classified. The present disclosure may refer to this vehicle as a cut-in candidate vehicle. A cut-in vehicle determined to have an intention to cut-in may be classified among the cut-in candidate vehicles.

In addition, if there is a cut-in vehicle, the vehicle control device may control the driving speed of the host vehicle (S210). If it is determined that a cut-in vehicle exists, the controller of the vehicle control device may determine the changed driving speed of the host vehicle based on the relative speed of the cut-in vehicle and the host vehicle, and control the host vehicle based on the changed driving speed.

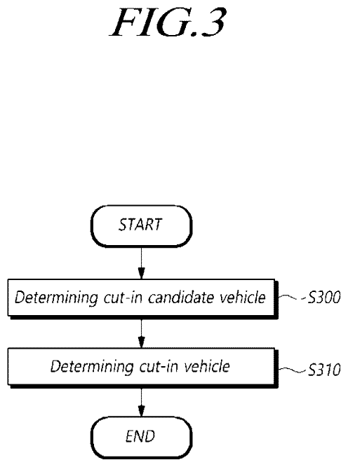

FIG. 3 is a flowchart for explaining a process of determining whether a surrounding vehicle is a cut-in vehicle according to one embodiment.

Referring to FIG. 3, the determination of whether a surrounding vehicle is a cut-in vehicle may be performed through a process of determining whether there is a cut-in candidate vehicle among the surrounding vehicles (S300), and a process of determining whether there is a cut-in vehicle among the cut-in candidate vehicles (S310).

A surrounding vehicle may be determined a cut-in candidate vehicle if the lateral speed of the surrounding vehicle increases or the driving path of the surrounding vehicle determined based on the heading angle of the surrounding vehicle overlaps with the expected driving path of the host vehicle (S300).

As an example, the controller of the vehicle control device may determine a surrounding vehicle as a cut-in candidate vehicle if the surrounding vehicle approaches while increasing its speed toward the host vehicle or if the surrounding vehicle is driving straight but the host vehicle approaches while increasing its speed toward the surrounding vehicle. That is, the lateral speed of the surrounding vehicle in the present disclosure may mean a lateral component of a relative speed between the host vehicle and the surrounding vehicle.

As another example, if the expected driving path of the host vehicle and the driving path of the surrounding vehicle are expected to overlap with each other, the vehicle control device of the present disclosure may determine a surrounding vehicle as a cut-in candidate vehicle. The driving path of the surrounding vehicle may be determined based on the heading angle of the surrounding vehicle detected by the sensing means equipped in the host vehicle. If the driving path of the surrounding vehicle overlaps with the expected driving path of the host vehicle, there may be determined that the surrounding vehicle may cut-in.

If it is determined that there is a cut-in candidate vehicle among the surrounding vehicles, the vehicle control device of the present disclosure may determine again whether the cut-in candidate vehicle has a cut-in intention based on the lateral speed and position information of the surrounding vehicle, and determine whether the cut-in vehicle exists (S310).

The position information of the surrounding vehicle may be a distance information from the cut-in candidate vehicle to a previously set reference line. The present disclosure proposes a method for detecting the surrounding vehicle based on the lateral speed of the cut-in candidate vehicle and the distance from the cut-in candidate vehicle to the reference line as a method for accurately determining the cut-in intention of the surrounding vehicle.

The vehicle control device of the present disclosure may determine that the cut-in candidate vehicle clearly has a cut-in intention if the lateral speed of the surrounding vehicle is fast and the distance between the cut-in candidate vehicle and the preset reference line is close.

The present disclosure may provide an effect of preventing misrecognition of the cut-in intention of the surrounding vehicle by clearly determining whether the surrounding vehicle is a cut-in vehicle based on the distance between the surrounding vehicle and the reference line.

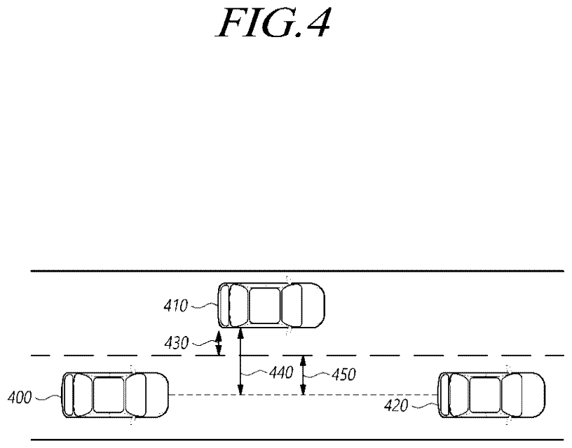

FIG. 4 is a diagram for explaining a method for determining a position of a surrounding vehicle according to an embodiment.

Referring to FIG. 4, the vehicle control device of the present disclosure may determine whether there is a cut-in candidate vehicle among surrounding vehicles 410 driving in the surrounding lane of a host vehicle 400 which is driving while maintaining a safe distance from a preceding vehicle 420, and determine whether there is a cut-in vehicle with a cut-in intention among the cut-in candidate vehicles. The determination of the cut-in intention of the cut-in candidate vehicle may be determined based on the distance from the cut-in candidate vehicle to the reference line. In addition, the distance from the cut-in candidate vehicle to the reference line may be determined based on a position of the cut-in candidate vehicle within a lane.

A position of the surrounding vehicle 410 may be determined based on at least one of a distance from the surrounding vehicle to the lane, the heading angle of the surrounding vehicle, the width information of the surrounding vehicle. The distance from the surrounding vehicle to the lane may be determined based on a difference between a distance between the host vehicle 400 and the surrounding vehicle and a distance from the host vehicle 400 to the surrounding vehicle and a distance from the host vehicle to the lane 450.

The distance from the host vehicle to the surrounding vehicle may be the shortest distance from a center of the host vehicle to the surrounding vehicle, and the distance from the host vehicle to the lane may be a distance from the center of the host vehicle to the lane.

In addition, the distance between the host vehicle and the surrounding vehicle may be the shortest distance from a specific part of the host vehicle to a specific part of the surrounding vehicle, and the distance from the host vehicle to the lane may be a distance from a specific part of the host vehicle to the lane.

The heading angle information and width information of the surrounding vehicle may be information included in information detected by a sensing means equipped in the host vehicle and transmitted to the receiver of the vehicle control device.

The method for determining the position and distance are not limited thereto, and may be implemented in various ways as needed.

For example, if the distance from the host vehicle to the lane is 20 m, and the distance from the host vehicle to a first part of the surrounding vehicle is 30 m, the distance from the first part of the surrounding vehicle to the lane may be 10 m. If the distance from the host vehicle to the lane is 25 m, and the distance from the host vehicle to ae second part of the surrounding vehicle is 30 m, the distance from the second part of the surrounding vehicle to the lane may be 5 m. In this way, the vehicle control device of the present disclosure may measure the distance to each part of the surrounding vehicle and determine the center position of the surrounding vehicle by utilizing the width information of the surrounding vehicle.

As another example, the vehicle control device of the present disclosure may directly receive the position information of the surrounding vehicle through a global positioning system (GPS).

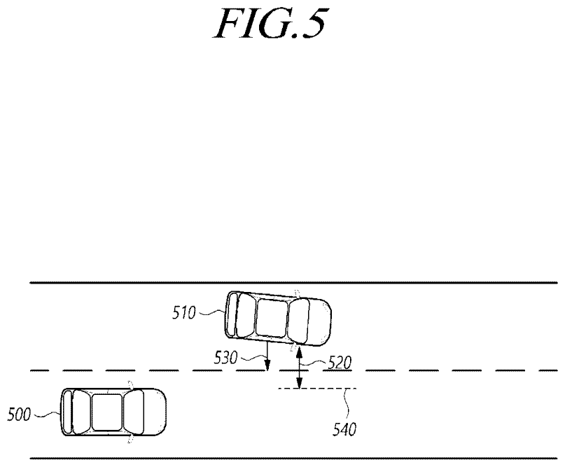

FIG. 5 is a diagram for explaining a method for determining whether a cut-in candidate vehicle is a cut-in vehicle according to an embodiment.

Referring to FIG. 5, if it is determined that there is a cut-in candidate vehicle among surrounding vehicles, the controller of the vehicle control device may determine a cut-in vehicle among the cut-in candidate vehicles. The reason for performing this process is to prevent unnecessary deceleration control from being performed on the host vehicle due to a vehicle among the cut-in candidate vehicles that does not actually have the intention of being cut-in and therefore has no risk of collision.

The present disclosure may set two criteria for determining whether a cut-in candidate vehicle is a cut-in vehicle. A cut-in candidate vehicle that satisfies both criteria may be determined to be a cut-in vehicle.

Specifically, the vehicle control device of the present disclosure may determine a cut-in candidate vehicle as a cut-in vehicle if the lateral speed 530 of a cut-in candidate vehicle exceeds a preset first threshold and a distance 520 between the cut-in candidate vehicle and a preset reference line is less than or equal to a preset second threshold.

The vehicle control device of the present disclosure may determine whether a cut-in candidate vehicle 510 is located close to the preset reference line 540. The preset reference line 540 may refer to a specific part of the lane in which a host vehicle 500 is driving. The location of the reference line 540 is not limited thereto, and may be set to a specific part of a lane in which the cut-in candidate vehicle 510 is driving.

The distance 520 between the cut-in candidate vehicle 510 and the reference line 540 may refer to a lateral distance from the position of the cut-in candidate vehicle 510 to the reference line 540, or may refer to a lateral distance between a specific part of the cut-in candidate vehicle 510 and the reference line 540.

The distance 520 between the cut-in candidate vehicle 510 and the reference line 540 may be determined based on the position of the cut-in candidate vehicle 510 and the reference line information.

In addition, the vehicle control device of the present disclosure may determine the cut-in candidate vehicle as a cut-in vehicle if the lateral speed 530 of the cut-in candidate vehicle exceeds a preset first threshold and the distance 520 between the cut-in candidate vehicle and the preset reference line is less than or equal to a preset second threshold.

If the lateral speed of the cut-in candidate vehicle is slow, the possibility of collision between the surrounding vehicle and the host vehicle may be low, and since the driver may control the host vehicle by himself, there is no need to determine the cut-in intention of the surrounding vehicle. In addition, if only the lateral speed of the cut-in candidate vehicle is fast, there is a possibility of incorrectly determining the cut-in intention as described above, so the vehicle control device of the present disclosure may determine the cut-in candidate vehicle as a cut-in vehicle if the lateral speed of the cut-in candidate vehicle is fast and the position of the cut-in candidate vehicle is close to the reference line.

Therefore, the vehicle control device of the present disclosure may determine the cut-in candidate vehicle as a vehicle not having cut-in intention if the lateral speed 530 of the cut-in candidate vehicle is lower than or equal to a preset first threshold or if the distance 520 between the cut-in candidate vehicle and a preset reference line exceeds a preset second threshold.

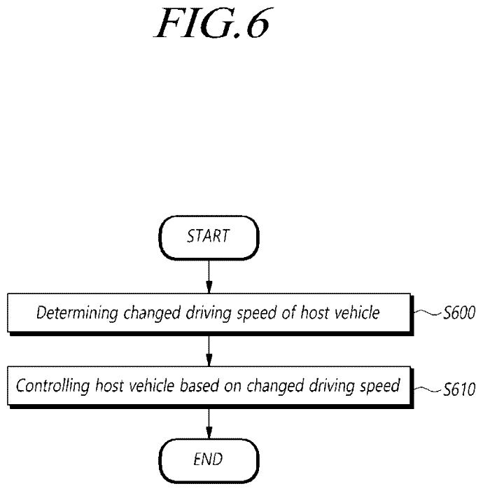

FIG. 6 is a flowchart for explaining a process of controlling a host vehicle in response to the presence of a cut-in vehicle according to an embodiment.

Referring to FIG. 6, if it is determined that there is a cut-in vehicle among the surrounding vehicles, the vehicle control device of the present disclosure may determine that a collision between the cut-in vehicle and the host vehicle is expected, and thus it is necessary to control the deceleration of the host vehicle. Accordingly, the controller of the vehicle control device may determine a changed driving speed of the host vehicle (S600), and control the host vehicle based on the determined result (S610).

Specifically, the changed driving speed of the host vehicle may be determined based on a relative speed between the host vehicle and a cut-in vehicle (S600).

The relative speed may be determined based on the difference between the driving speed of the host vehicle and the lateral speed of the cut-in vehicle, and may also be determined based on the difference between the driving speed of the host vehicle and the driving speed of the cut-in vehicle.

For example, in the case that the controller of the vehicle control device determines the relative speed based on the driving speed of the host vehicle and the driving speed of the cut-in vehicle, if the driving speed of the host vehicle is 70 km/h and the driving speed of the cut-in vehicle is 60 km/h, the relative speed may be 10 km/h, so the vehicle control device may determine the changed driving speed as 60 km/h, which is a 10 km/h decrease from 70 km/h.

However, if the driving speed of the host vehicle is 60 km/h and the driving speed of the cut-in vehicle is 70 km/h, since the relative speed is-10 km/h, the vehicle control device may not determine to decelerate the driving speed of the host vehicle.

The present disclosure may prevent the risk of collision between the two vehicles by performing deceleration control of the host vehicle using the relative speeds of the host vehicle and the cut-in vehicle.

If the changed driving speed is determined as described above, the vehicle control device may decelerate or control the driving speed of the host vehicle (S610).

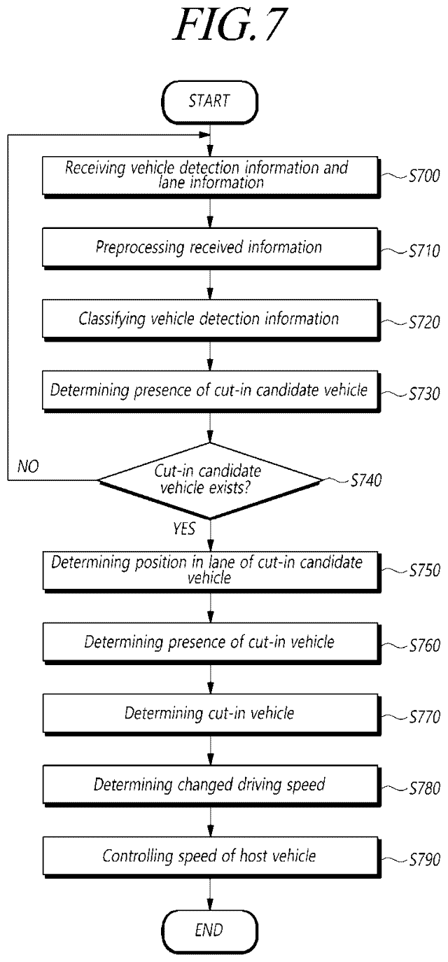

FIG. 7 is a flowchart for exemplarily explaining the entire process of controlling a host vehicle according to the result of determining a cut-in intention of a surrounding vehicle according to an embodiment.

Referring to FIG. 7, the vehicle control method may control the host vehicle by determining the cut-in intention of the surrounding vehicle.

The vehicle control method may include receiving vehicle information and lane information detected from the sensing means equipped in the host vehicle (S700). The vehicle information may include information about the host vehicle or surrounding vehicles, and may also include information about ae preceding vehicle in front of the host vehicle as needed. The lane information may be used to determine a position of a surrounding vehicle.

In addition, the vehicle control method may include processing the received information into a state necessary for determining the cut-in vehicle (S710). The information on the vehicles and a line or lane received from the sensing means may be received in various ways depending on the sensing means equipped in the vehicle. Therefore, preprocessing may be performed to process the data so as to be used for determining the cut-in intention of the vehicle, including determining the position of the surrounding vehicle.

In addition, the received information may be classified based on the received vehicle information (S720). The received information may be classified as needed and stored in a database. The classification criteria may be set in various ways, such as vehicle type, vehicle size, and a position where the vehicle is located.

In addition, the cut-in situation may be analyzed based on the received information (S730). The analysis of the cut-in situation may include a process of determining whether there is a cut-in candidate vehicle among the surrounding vehicles. The existence of the cut-in candidate vehicle may be determined based on the lateral speed information of the surrounding vehicles and the expected driving path of the host vehicle.

In addition, there may be determined whether there is a cut-in candidate vehicle among the surrounding vehicles (S740).

In addition, if there is a cut-in candidate vehicle, the position of the cut-in candidate vehicle within the lane may be determined, and if there is no cut-in candidate vehicle, the vehicle can be driven in the normal manner (S750). The position of the cut-in candidate vehicle within the lane may be determined based on at least one of the width information of the cut-in candidate vehicle, the distance information between the cut-in candidate vehicle and the host vehicle, the distance information between the cut-in candidate vehicle and the lane, and the distance information between the host vehicle and the lane.

In addition, the cut-in vehicle may be determined based on the position of the cut-in candidate vehicle within the lane (S760). The presence of the cut-in vehicle may be determined based on the lateral speed information of the cut-in candidate vehicle and the distance information from the cut-in candidate vehicle to the reference line. The distance from the cut-in candidate vehicle to the reference line may be determined based on the position information of the cut-in candidate vehicle.

In addition, if the cut-in vehicle exists, there may be determined to control the host vehicle (S770).

In addition, the vehicle control method of the present disclosure may include determining a changed driving speed of the host vehicle if the host vehicle control is determined due to the presence of the cut-in vehicle (S780). The changed driving speed of the host vehicle may be determined based on the relative speed of the cut-in vehicle and the host vehicle.

In addition, the host vehicle may be controlled based on the generated changed driving speed (S790).

Each of the above-described steps is an example, and a part of the steps may be omitted or the order of executing the steps may be changed.

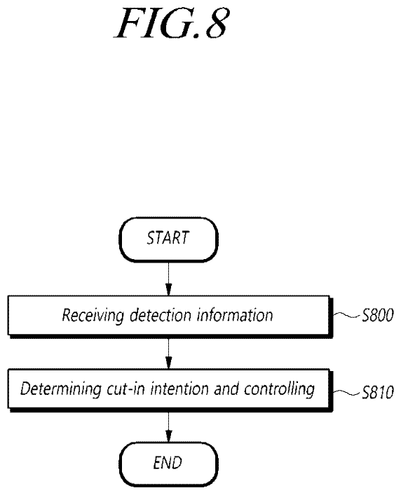

FIG. 8 is a flowchart for explaining a vehicle control method according to the result of determining a cut-in intention of a surrounding vehicle in an embodiment.

Referring to FIG. 8, a method for controlling a host vehicle with respect to a cut-in vehicle may include a receiving step for receiving detection information related to the host vehicle and surrounding vehicles (S800).

As an example, the detection information received by the receiving step may include at least one of an expected driving path of the host vehicle, a lateral speed of a surrounding vehicle, a heading angle of the surrounding vehicle, and lane information between the host vehicle and the surrounding vehicle.

The detection information may be information detected by a sensing device equipped in the host vehicle. If the sensing device collects information about the host vehicle, surrounding vehicles, and lanes, the sensing device may transmit the collected information to the receiver of the present disclosure. The sensing device may be either a camera or a radar.

A method for controlling a host vehicle with respect to a cut-in vehicle may include a control step of determining the existence of a cut-in candidate vehicle based on a cut-in intention determination result for a surrounding vehicle based on detection information, and determining whether a cut-in vehicle exists based on a position of the cut-in candidate vehicle in a lane if a cut-in candidate vehicle exists (S810).

The vehicle control device of the present disclosure first may determine whether there is a cut-in candidate vehicle among surrounding vehicles based on a preset determination criterion, and then determine whether there is a cut-in vehicle among the cut-in candidate vehicles based on the lateral speed and a position of the cut-in candidate vehicle, then determine a changed driving speed of the host vehicle based on the relative speed of the cut-in vehicle and the host vehicle if the cut-in vehicle exists, and controls the host vehicle based on the changed driving speed.

As an example, the control step may include determining a surrounding vehicle as a cut-in candidate vehicle based on at least one of an expected driving path of the host vehicle, a lateral speed of the surrounding vehicle, and a heading angle of the surrounding vehicle.

The host vehicle and a surrounding vehicle may be autonomous vehicles controlled by a control center. The cut-in may be performed by either the host vehicle or the surrounding vehicle. The vehicle control device of the present disclosure may determine whether the surrounding vehicle has a cut-in intention with respect to the host vehicle, and control the speed of the host vehicle if the surrounding vehicle is a vehicle having a cut-in intention.

As another example, the control step may include primarily determining a vehicle among the surrounding vehicles expected to have a cut-in intention as a cut-in candidate vehicle based on information received through the receiving step. Determining the surrounding vehicle as a cut-in candidate vehicle may be performed based on at least one of the expected driving path of the host vehicle, the lateral speed of the surrounding vehicle, and the heading angle of the surrounding vehicle.

As another example, the control step may include performing a preprocessing data into a state in which the receiving step determines whether the surrounding vehicle is a cut-in vehicle. Alternatively, the control step may include classifying and storing information such as the vehicle type, width, height, and location of the surrounding vehicle in a separate database based on information about the surrounding vehicle received through the receiving step.

As another example, the control step may include determining a specific surrounding vehicle as a cut-in candidate vehicle if the lateral speed of the surrounding vehicle increases or the driving direction of the surrounding vehicle measured based on the heading angle overlaps with the expected driving path of the host vehicle. Specifically, the controller may determine the surrounding vehicle as a cut-in candidate vehicle if the lateral speed of the surrounding vehicle increases, determine a driving direction of the surrounding vehicle through the heading angle of the surrounding vehicle, and determine the surrounding vehicle as a cut-in candidate vehicle if the driving direction overlaps with the expected driving path of the host vehicle. However, since the sensor may incorrectly detect the lateral speed, and it is not necessarily considered that a collision has occurred even if the driving paths overlap with each other, the cut-in intention of the surrounding vehicle may not be clearly determined based on the above-described criteria alone, and the cut-in intention may be misrecognized and the host vehicle may be unnecessarily decelerated. Therefore, the vehicle control method of the present disclosure proposes a method of determining whether the cut-in candidate vehicle is a cut-in vehicle based on the vehicle position information for the cut-in candidate vehicle that is primarily determined.

As another example, the control step may include determining a cut-in candidate vehicle as a cut-in vehicle based on the lateral speed of the surrounding vehicle and the distance from the surrounding vehicle to a reference line.

The vehicle control method may include determining a cut-in candidate vehicle as a cut-in vehicle if it is determined that the cut-in candidate vehicle is rapidly approaching the host vehicle and the position of the surrounding vehicle is close to a previously set reference line. The reference line may mean a specific location within the lane in which the host vehicle is driving or a specific location within the lane in which the surrounding vehicle is driving.

As another example, the control step may include determining a cut-in candidate vehicle as a cut-in vehicle if the lateral speed of the surrounding vehicle exceeds a first threshold and the distance from the surrounding vehicle to the reference line is less than or equal to a second threshold.

In determining the cut-in candidate vehicle as the cut-in vehicle, a reference value of the lateral speed and a reference value or threshold value for the distance between the cut-in candidate vehicle and the reference line may be set in advance.

As another example, the distance from the surrounding vehicle to the reference line may be determined based on the position within the lane of the surrounding vehicle, and the position within the lane of the surrounding vehicle may be determined based on the received lane information between the host vehicle and the surrounding vehicle.

Specifically, the distance between the cut-in candidate vehicle and the reference line may be determined using information such as the position within the lane of the cut-in candidate vehicle, heading angle of the cut-in candidate vehicle, and width of the cut-in candidate vehicle, In addition, since the possibility of collision with the host vehicle may vary depending on the width of the cut-in candidate vehicle, the distance from the cut-in candidate vehicle to the reference line may mean a shortest distance among the distances between each part of the cut-in candidate vehicle and the reference line.

In addition, the position within the lane of the cut-in candidate vehicle may be detected by a sensing means equipped in the host vehicle. Alternatively, the position information measured through GPS may be received, or the controller may determine the position based on information about the detected cut-in candidate vehicle and lane information located between the cut-in candidate vehicle and the host vehicle. Information about the cut-in candidate vehicle may include width information of the cut-in candidate vehicle described above, and lane information may be location information of the lane. By using the information about the cut-in candidate vehicle and the lane information, there may be determined the distance between the cut-in candidate vehicle and the lane, and the position of the cut-in candidate vehicle may be accurately measured based on the distance information. Therefore, the present disclosure proposes a method for determining the position of the cut-in candidate vehicle based on distance information between the cut-in candidate vehicle and the lane.

As another example, the control step may include determining the changed driving speed of the host vehicle based on the relative speed between the host vehicle and the cut-in vehicle in response to the presence of the cut-in vehicle. If the controller determines that there is a cut-in vehicle among the cut-in candidate vehicles, there may be required to control the speed of the host vehicle to prevent a collision between the cut-in vehicle and the host vehicle. Therefore, the vehicle control method of the present disclosure may include determining the driving speed of the host vehicle. In the present disclosure, the determined driving speed of the host vehicle may be referred to as a changed driving speed of the host vehicle. The control step may include determining the changed driving speed based on the relative speed between the host vehicle and the cut-in vehicle.

As another example, the control step include controlling the host vehicle based on the determined changed driving speed.

As another example, the control step may include transmitting a message notifying the risk of collision to the host vehicle if a cut-in candidate vehicle exists, and transmitting a message notifying the host vehicle that there is an error in the notification of the risk of collision if a cut-in candidate vehicle exists but a cut-in vehicle does not exist. The host vehicle may have a driver on board, and the driver may control the host vehicle by himself even though it is an autonomous vehicle. In this case, the vehicle control device of the present disclosure may notify the driver that there is a risk of collision with the cut-in candidate vehicle. The notification of the risk of collision may be transmitted as a voice through an audio device equipped in the host vehicle, or may be transmitted as a visual message through a display device equipped in the host vehicle. The method of notifying the driver of the risk is not limited thereto, and may be implemented in various ways depending on the vehicle type or condition of the host vehicle.

Through the operations of the above-described steps, there may be accurately distinguished a cut-in vehicle with a cut-in intention among surrounding vehicles. Accordingly, it is possible to prevent unnecessary deceleration control of the host vehicle.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A vehicle control device comprising:
a receiver for receiving detection information related to a host vehicle and a surrounding vehicle; and
a controller configured to determine the presence of a cut-in candidate vehicle based on a cut-in intention determination result for the surrounding vehicle based on the detection information, and determine the presence of a cut-in vehicle based on a position within a lane of the cut-in candidate vehicle if the cut-in candidate vehicle exists.

2. The vehicle control device of claim 1, wherein the detection information includes at least one of an expected driving path of the host vehicle, a lateral speed of the surrounding vehicle, a heading angle of the surrounding vehicle, and lane information between the host vehicle and the surrounding vehicle.

3. The vehicle control device of claim 2, wherein the controller determines the surrounding s the cut-in candidate vehicle based on at least one of the expected driving path of the host vehicle, the lateral speed of the surrounding vehicle, and the heading angle of the surrounding vehicle.

4. The vehicle control device of claim 3, wherein, if the lateral speed of the surrounding vehicle increases or a driving direction of the surrounding vehicle based on the heading angle overlaps with the expected driving path of the host vehicle, the controller determines the surrounding vehicle as the cut-in candidate vehicle.

5. The vehicle control device of claim 2, wherein the controller determines the cut-in candidate vehicle as the cut-in vehicle based on the lateral speed of the surrounding vehicle and a distance from the surrounding vehicle to a reference line.

6. The vehicle control device of claim 5, wherein the controller determines the cut-in candidate vehicle as the cut-in vehicle if the lateral speed exceeds a first threshold and the distance is less than or equal to a second threshold.

7. The vehicle control device of claim 5, wherein the distance from the surrounding vehicle to the reference line is determined based on the position within the lane of the surrounding vehicle,
wherein the position within the lane of the surrounding vehicle is determined based on the lane information between the host vehicle and the surrounding vehicle.

8. The vehicle control device of claim 1, wherein the controller determines a changed driving speed of the host vehicle based on a relative speed of the host vehicle and the cut-in vehicle if the cut-in vehicle exists.

9. The vehicle control device of claim 8, wherein the controller controls the host vehicle based on the changed driving speed.

10. The vehicle control device of claim 1, wherein the controller transmits a message to the host vehicle to notify a collision risk if the cut-in candidate vehicle exists,
wherein the controller transmits a message to the host vehicle to notify an error in a notification of the collision risk if the cut-in candidate vehicle exists and the cut-in vehicle does not exist.

11. A vehicle control method comprising:
receiving detection information related to a host vehicle and a surrounding vehicle; and
determining the presence of a cut-in candidate vehicle based on a cut-in intention determination result for the surrounding vehicle based on the detection information, and determining the presence of a cut-in vehicle based on a position within a lane of the cut-in candidate vehicle if the cut-in candidate vehicle exists.

12. The vehicle control method of claim 11, wherein the detection information includes at least one of an expected driving path of the host vehicle, a lateral speed of the surrounding vehicle, a heading angle of the surrounding vehicle, and lane information between the host vehicle and the surrounding vehicle.

13. The vehicle control method of claim 12, wherein the determining comprises determining the surrounding vehicle as the cut-in candidate vehicle based on at least one of the expected driving path of the host vehicle, the lateral speed of the surrounding vehicle, and the heading angle of the surrounding vehicle.

14. The vehicle control method of claim 13, wherein, if the lateral speed of the surrounding vehicle increases or a driving direction of the surrounding vehicle based on the heading angle overlaps with the expected driving path of the host vehicle, the determining comprises determining the surrounding vehicle as the cut-in candidate vehicle.

15. The vehicle control method of claim 12, wherein the determining comprises determining the cut-in candidate vehicle as the cut-in vehicle based on the lateral speed of the surrounding vehicle and a distance from the surrounding vehicle to a reference line.

16. The vehicle control method of claim 15, wherein the determining comprises determining the cut-in candidate vehicle as the cut-in vehicle if the lateral speed exceeds a first threshold and the distance is less than or equal to a second threshold.

17. The vehicle control method of claim 15, wherein the distance from the surrounding vehicle to the reference line is determined based on the position within the lane of the surrounding vehicle,
wherein the position within the lane of the surrounding vehicle is determined based on the lane information between the host vehicle and the surrounding vehicle.

18. The vehicle control method of claim 11, wherein the determining comprises determining a changed driving speed of the host vehicle based on a relative speed of the host vehicle and the cut-in vehicle if the cut-in vehicle exists.

19. The vehicle control method of claim 18, further comprising controlling the host vehicle based on the changed driving speed.

20. The vehicle control method of claim 11, further comprising transmitting a message to the host vehicle to notify a collision risk if the cut-in candidate vehicle exists, and transmitting a message to the host vehicle to notify an error in a notification of the collision risk if the cut-in candidate vehicle exists and the cut-in vehicle does not exist.
